(19) United States
(12) Patent Application Publication
(10) Pub. No.: US 2007/0103382 A1
(43) Pub. Date: May 10, 2007

(54) Portable terminal having single extended screen for dual display panels, method of controlling screen display thereof and control device thereof

(75) Inventors: Young Hoon Chang, Gyeonggi-do (KR); Hong Jae Shin, Seoul (KR)

Correspondence Address: HARNESS, DICKEY & PIERCE, P.L.C., P.O. BOX 828, BLOOMFIELD HILLS, MI, 48303, US

(73) Assignee: Hana Micron Co., Ltd., Chungcheongnam-do (KR)

(21) Appl. No.: 10/580,473

(22) PCT Filed: Dec. 1, 2004
(86) PCT No.: PCT/KR04/03141

§ 371 Date: Nov. 27, 2006

(30) Foreign Application Priority Data
Dec. 1, 2003 (KR) 10-2003-0086441

(51) Int. Cl. G09G 5/00

(52) U.S. Cl. 345/1.1

(57) ABSTRACT

Disclosed are a single extended screen formed by a dual display panel, and a method and a device for controlling display on the screen. A portable terminal having a dual display panel comprises a body having a plurality of function keys and number keys; and a folder coupled to the body by hinges to be folded and unfolded about the hinges, and having on one surface thereof a main display panel and on the other surface thereof a sub display panel which is coupled to the folder by hinges to be folded and unfolded about the hinges, the folder being capable of providing a single extended screen through combination of the main display panel and the sub display panel.

### Technical Field

The present invention relates to a portable terminal having a single extended screen formed by a dual display panel, and a method and device for controlling display on the screen, and more particularly, to a portable terminal having a single extended screen formed by a dual display panel in which a sub display panel capable of being folded and unfolded about hinges is provided to one surface of a folder having a main display panel on the other surface thereof so that the single extended screen can be formed by combining a main display panel and the sub display panel, and a method and a device for controlling display on the screen.

### BACKGROUND ART

These days, the use of portable terminals has rapidly increased since they have a compact size and are convenient to use. Portable terminals are generally divided into a bar type, a flip type, a folder type, and a sliding folder type.

In these portable terminals, power of a battery, a received signal strength for indicating whether or not communication service is possible, SMS (short message service) information, a caller identification (CID), a time, etc. are displayed on a panel so that the user can conveniently use the portable terminal by confirming these information. As the panel, a display such as an FPD (flat panel display) is adopted in view of its improved portability. That is, an LCD or a TFT (thin film transistor) LCD is widely used, and the use of an organic LED has increased in consideration of advantages rendered in respect of response speed, size, etc. as portable terminals shrink in size.

In folder type portable terminals having a dual display panel which have recently been distributed all over the world, a main display panel is provided on an inside of a folder and a sub display panel is provided on the outside of the folder, so that various information can be easily confirmed even with the folder closed.

FIGS. 1 through 3 are views illustrating outer appearances of a portable terminal having a dual display panel according to the conventional art, wherein FIG. 1 is a perspective view illustrating the outer appearance of the folded portable terminal, FIG. 2 is a perspective view illustrating the outer appearance of the unfolded portable terminal viewed from the outside, and FIG. 3 is a perspective view illustrating the outer appearance of the unfolded portable terminal viewed from the inside.

As shown in FIGS. 1 through 3, a portable terminal 10 having a dual display panel according to the conventional art comprises a folder 10a and a body 10b. The folder 10a and the body 10b are coupled to each other by hinges 11 so that the folder 10a can be opened and closed from and to the body 10b. On the inside of the folder 10a, there are provided a main display panel 15 serving as a liquid crystal screen for display and an earphone 16, and on the outside of the folder 10a, there is provided a sub display panel 14 serving as a liquid crystal screen for display. On the inside of the body 10b, there are provided a keypad 17 including various function keys and number keys and a microphone 18, and on the outside of the body 10b, there are provided a battery 13 and an antenna 12.

FIG. 4 is a block diagram illustrating a display module of the portable terminal having a dual display panel according to the conventional art.

As shown in FIG. 4, a display module 20 comprises the main display panel 15, a main scan driver 15a, a main data driver 15b, a main display panel controller 15c, the sub display panel 14, a sub scan driver 14a, a sub data driver 14b, and a sub display panel controller 14c.

In the main display panel 15, a plurality of row lines and a plurality of column lines are constructed in the shape of a matrix to define a plurality of pixels. Operation of the main display panel 15 is controlled by the main scan driver 15a, the main data driver 15b and the main display panel controller 15c.

The main scan driver 15a implements scanning operation for sequentially selecting the row lines (arranged on a Y axis) of the main display panel 15.

The main data driver 15b converts image data to be displayed into a voltage or a current, and then applies the converted voltage or current to the column lines (arranged on an X axis) of the main display panel 15.

The main display panel controller 15c applies a scan signal to the main scan driver 15a and an image data signal to the main data driver 15b to respectively control operation of the main scan driver 15a and the main data driver 15b.

In the sub display panel 14, a plurality of row lines and a plurality of column lines are constructed in the shape of a matrix to define a plurality of pixels. Operation of the sub display panel 14 is controlled by the sub scan driver 14a, the sub data driver 14b and the sub display panel controller 14c.

The sub scan driver 14a implements scanning operation for sequentially selecting the row lines (arranged on a Y axis) of the sub display panel 14.

The sub data driver 14b converts image data to be displayed into a voltage or a current, and then applies the converted voltage or current to the column lines (arranged on an X axis) of the sub display panel 14.

The sub display panel controller 14c applies a scan signal to the sub scan driver 14a and an image data signal to the sub data driver 14b to respectively control operation of the sub scan driver 14a and the sub data driver 14b.

As the portable terminals each having a dual display panel according to the conventional art, Korean Patent Laid-open Publication No. 2002-14248 discloses a portable phone having a dual LCD in which an upper part of a folder is structured to be folded one more time, and Korean Patent Laid-open Publication No. 2002-36183 discloses a portable phone mounted with a double LCD in which a second LCD can be moved in a vertical direction with respect to a first LCD by using rotary bars. Further, Korean Patent Laid-open Publication No. 2003-37126 discloses a folder type portable phone having a dual LCD and a method and a device for controlling display on a window screen of the portable phone, in which a sub LCD can be laterally folded and unfolded about hinges.

However, the conventional folder type portable terminals each having a dual display panel, constructed as mentioned above, suffer from defects in that, since the main display panel 15 and the sub display panel 14 are independently constructed, it is difficult to produce a large image such as one having an aspect ratio of 16:9. That is to say, in the case of a large image such as HDTV multi-media contents having an aspect ratio of 16:9, the original 16:9 aspect ratio is not reproduced as it is, but instead, is reproduced in conformity with the shape of the main display panel 15 provided to a portable terminal, whereby reproducibility of digital contents is markedly deteriorated and the shape of the screen is distorted.

Also, the conventional folder type portable terminals each having a dual display panel are encountered with a problem in that, since a display module comprises two display controllers which are respectively provided for the main display panel 15 and the sub display panel 14 to control operation of the main display panel 15 and the sub display panel 14, circuits occupy an increased area and power consumption increases.

In this regard, as functionality of a portable terminal is gradually complicated, a main display panel and a sub display panel of the portable terminal gradually tend toward larger sizes, and functionality of digital multi-media such as moving pictures and the like (for example, reception of HDTV image by a portable terminal) gradually increases.

### Disclosure of the Invention

Accordingly, the present invention has been made in an effort to solve the problems occurring in the related art, and an object of the present invention is to provide a portable terminal having a single extended screen formed by a dual display panel in which the single extended screen is formed by combining two screens constituted by a main display panel and a sub display panel, and a method and a device for controlling display on the screen.

Another object of the present invention is to provide a portable terminal having a single extended screen formed by a dual display panel in which two screens constituted by a main display panel and a sub display panel are combined to form a single integrated screen having no substantial gap between the two screens, and a method and a device for controlling display on the screen.

Another object of the present invention is to provide a portable terminal having a single extended screen formed by a dual display panel in which two screens constituted by a main display panel and a sub display panel are combined to form a single integrated screen having no substantial gap between the two screens so that an image having a large aspect ratio such as 16:9 can be displayed on the integrated screen, and a method and a device for controlling display on the screen.

Another object of the present invention is to provide a portable terminal having a single extended screen formed by a dual display panel in which two screens constituted by a main display panel and a sub display panel are combined to form a single integrated screen having no substantial gap between the two screens so that an image having a large aspect ratio such as 16:9 and dialogues and additional information such as communication information and the like can be displayed on the integrated screen, and a method and a device for controlling display on the screen.

Another object of the present invention is to provide a portable terminal having a single extended screen formed by a dual display panel in which two display controllers for respectively controlling a main display panel and a sub display panel are embodied in a single chip to thereby enabling optimization of a circuit size and accomplishing a lower power operation characteristic, and a method and a device for controlling display on the screen.

Another object of the present invention is to provide a portable terminal having a single extended screen formed by a dual display panel in which main icons and sub icons are positioned in the same direction on a single integrated screen constituted by a main display panel and a sub display panel, and a method and a device for controlling display on the screen.

Another object of the present invention is to provide a portable terminal having a single extended screen formed by a dual display panel in which sub icons are embodied to accomplish symmetrical arrangement structures in a manner such that the sub icons have the same proper shapes irrespective of operation for folding and unfolding a sub display panel, and a method and a device for controlling display on the screen.

Another object of the present invention is to provide a portable terminal having a single extended screen formed by a dual display panel in which main icons arranged on a single integrated screen constituted by a main display panel and a sub display panel are embodied as functional icons, and a method and a device for controlling display on the screen.

In order to achieve the above objects, according to one aspect of the present invention, there is provided a portable terminal having a dual display panel, comprising: a body having a plurality of function keys and number keys; and a folder coupled to the body by hinges to be folded and unfolded about the hinges, and having on one surface thereof a main display panel and on the other surface thereof a sub display panel which is coupled to the folder by hinges to be folded and unfolded about the hinges, the folder being capable of providing a single extended screen through cooperation of the main display panel and the sub display panel.

According to another aspect of the present invention, the folder provides the single extended screen having no substantial gap thereon, through cooperation of the main display panel and the sub display panel.

According to another aspect of the present invention, the main display panel and the sub display panel are formed to extend to an edge of the folder such that no substantial gap is created between the main display panel and the sub display panel when the sub display panel is unfolded.

According to another aspect of the present invention, the single extended screen comprises a window screen having an aspect ratio of 16:9.

According to another aspect of the present invention, the portable terminal further comprises a flip sensor for sensing folded and unfolded states of the sub display panel.

According to another aspect of the present invention, at least one of text information including a translated dialogue and communication information of the portable terminal is displayed on a portion of the screen.

According to another aspect of the present invention, an antenna of the portable terminal is installed to be positioned opposite to the hinges by which the sub display panel is coupled to the folder.

According to another aspect of the present invention, main icons configured on the main display panel and sub icons configured on the sub display panel are arranged in the same direction when the sub display panel is unfolded.

According to another aspect of the present invention, a menu function is provided to the main icons by using one of an under bar, a square and a reverse so that a corresponding operation can be implemented.

According to another aspect of the present invention, the sub icons have shapes which are symmetrical in both longitudinal and transverse directions so that expressional functionality of the sub icons is maintained when the sub display panel is unfolded.

According to another aspect of the present invention, each of the main display panel and the sub display panel comprises a flat panel display such as an organic LED and an LCD.

According to another aspect of the present invention, the portable terminal further comprises a display module for controlling the main display panel and the sub display panel such that the main display panel and the sub display panel are independently driven when the sub display panel is folded and are cooperatively driven to form the single extended screen when the sub display panel is unfolded.

According to another aspect of the present invention, the display module comprises a main scan driver for sequentially selecting and scanning row lines of the main display panel; a main data driver for applying image data signals to column lines of the main display panel; a sub scan driver for sequentially selecting and scanning row lines of the sub display panel; a sub data driver for applying image data signals to column lines of the sub display panel; and a controller for implementing a control task such that the main scan driver and the main data driver are driven to operate the main display panel and such that the main scan driver, the main data driver, the sub scan driver and the sub data driver are driven to operate the main display panel and the sub display panel to form the single extended screen.

According to another aspect of the present invention, the controller comprises a window read/write circuit section for reading and writing window data from and to a main system of the portable terminal; a main video memory for storing main scan data signals and main image data signals for driving the main display panel; a sub video memory for storing sub scan data signals and sub image data signals for driving the sub display panel; a logical/physical mapping circuit section for logically or physically mapping data transmitted between the main video memory and the sub video memory and the window read/write circuit section; an XY converting logic section for XY-converting and outputting the sub scan data signals and the sub image data signals stored in the sub video memory, in response to a signal from a flip sensor; a main scan/data interface section for transmitting the main scan data signals and the main image data signals received from the main video memory to the main scan driver and the main data driver; and a sub scan/data interface section for transmitting the sub scan data signals and the sub image data signals received from the XY converting logic section to the sub scan driver and the sub data driver.

According to another aspect of the present invention, the logical/physical mapping circuit section comprises a subtracter for receiving a coordinate XL and a coordinate Xₘ; an adder for receiving a coordinate YL and a coordinate Yₘ; a first comparator for receiving the coordinate XL and a coordinate 0; a second comparator for receiving the coordinate XL and the coordinate Xₘ; a third comparator for receiving the coordinate XL and a coordinate Xₘ+Xₛ; a logic combining section for receiving output signals from the first through third comparators; a first MUX for selecting one of the coordinate XL and an output signal from the subtracter in response to an output signal from the logic combining section and outputting the selected one as a coordinate XP; and a second MUX for selecting one of the coordinate YL and an output signal from the adder in response to an output signal from the logic combining section and outputting the selected one as a coordinate YP; wherein the coordinates (XL,YL) are coordinates on a window W1 of a logical display memory, the coordinates (Xₘ,Yₘ) are coordinates of the main display panel having a screen size of Xₘ×Yₘ, the coordinates (Xₛ,Yₛ) are coordinates of the sub display panel W2 having a screen size of Xₛ×Yₛ, and the coordinates (XP,YP) are coordinates of a physical video memory which correspond to the coordinates (XL,YL) on the window W1 of the logical display memory.

According to another aspect of the present invention, the window read/write circuit section comprises a first subtracter for receiving a coordinate Xe and a coordinate Xb; a first register for storing an output signal of the first subtracter; a first adder for receiving an output signal of the first register and adding one by one; a second subtracter for receiving a coordinate Ye and a coordinate Yb; a second register for storing an output signal of the second subtracter; a second adder for receiving an output signal of the second register and adding one by one; a multiplexer for selecting one of output signals from the first and second adders; a third register for storing an output signal of the multiplexer; a control logic part for receiving an output signal of the third register, a clock signal and a read/write command signal; a counter circuit part for receiving an output signal of the control logic part; a modifier for receiving output signals of the first register and the counter circuit part; a divider for receiving output signals of the first register and the counter circuit part; a third adder for receiving an output signal of the modifier and the coordinate Xb and generating the coordinate XL; and a fourth adder for receiving an output signal of the divider and the coordinate Yb and generating the coordinate YL; wherein the coordinates (Xb,Yb) and (Xe,Ye) are coordinates on a window of the logical display memory, the coordinates (XL,YL) are coordinates on the window of the logical display memory, and inequalities Xe>Xb and Ye>Yb are satisfied.

According to another aspect of the present invention, there is provided a method for controlling display on a screen of a portable terminal having a body which possesses a plurality of function keys and number keys and a folder which is coupled to the body by hinges to be folded and unfolded about the hinges and possesses on one surface thereof a main display panel and on the other surface thereof a sub display panel coupled to the folder by hinges to be folded and unfolded about the hinges, the method comprising the steps of controlling by a controller the main display panel and the sub display panel when the sub display panel is folded, such that the main display panel and the sub display panel are independently driven; and controlling by the controller the main display panel and the sub display panel when the sub display panel is unfolded, such that the main display panel and the sub display panel are cooperatively driven to form a single extended screen having no substantial gap thereon.

According to another aspect of the present invention, the single extended screen comprises a window screen having an aspect ratio of 16:9.

According to another aspect of the present invention, when assuming that the main display panel has a size of Xₘ×Yₘ and the sub display panel has a size of Xₛ×Yₛ and when considering an equation for constructing the window screen of 16:9, (Xₘ+Xₛ):Yₛ=16:9, the window screen having the aspect ratio of 16:9 satisfies an inequality (Xₘ+Xₛ)≧16Yₛ/9 (Xₘ≧Xₛ and Yₘ≧Yₛ)

According to another aspect of the present invention, the main display panel and the sub display panel are formed to extend to an edge of the folder such that no substantial gap is created between the main display panel and the sub display panel when the sub display panel is unfolded to form the single extended screen.

According to another aspect of the present invention, at least one of text information including a translated dialogue and communication information of the portable terminal is displayed on a portion of the single extended screen.

According to another aspect of the present invention, main icons configured on the main display panel and sub icons configured on the sub display panel are arranged in the same direction when the sub display panel is unfolded to form the single extended screen.

According to another aspect of the present invention, a menu function is provided to the main icons by using one of an under bar, a square and a reverse so that a corresponding operation can be implemented.

According to another aspect of the present invention, the sub icons have shapes which are symmetrical in both longitudinal and transverse directions so that expressional functionality of the sub icons is maintained when the sub display panel is unfolded to form the single extended screen.

According to another aspect of the present invention, there is provided a device for controlling display on a screen of a portable terminal having a dual display panel, comprising a main scan driver for sequentially selecting and scanning row lines of a main display panel; a main data driver for applying image data signals to column lines of the main display panel; a sub scan driver for sequentially selecting and scanning row lines of a sub display panel; a sub data driver for applying image data signals to column lines of the sub display panel; and a controller for controlling the drivers such that the main display panel and the sub display panel are independently driven or the main display panel and the sub display panel are cooperatively driven to form a single extended screen.

According to another aspect of the present invention, the controller comprises a window read/write circuit section for reading and writing window data from and to a main system of the portable terminal; a main video memory for storing main scan data signals and main image data signals for driving the main display panel; a sub video memory for storing sub scan data signals and sub image data signals for driving the sub display panel; a logical/physical mapping circuit section for logically or physically mapping data transmitted between the main video memory and the sub video memory and the window read/write circuit section; an XY converting logic section for XY-converting and outputting the sub scan data signals and the sub image data signals stored in the sub video memory, in response to a signal from a flip sensor; a main scan/data interface section for transmitting the main scan data signals and the main image data signals received from the main video memory to the main scan driver and the main data driver; and a sub scan/data interface section for transmitting the sub scan data signals and the sub image data signals received from the XY converting logic section to the sub scan driver and the sub data driver.

According to still another aspect of the present invention, the logical/physical mapping circuit section comprises a subtracter for receiving a coordinate XL and a coordinate Xₘ; an adder for receiving a coordinate YL and a coordinate Yₘ; a first comparator for receiving the coordinate XL and a coordinate 0; a second comparator for receiving the coordinate XL and the coordinate Xₘ; a third comparator for receiving the coordinate XL and a coordinate Xₘ+Xₛ; a logic combining section for receiving output signals from the first through third comparators; a first MUX for selecting one of the coordinate XL and an output signal from the subtracter in response to an output signal from the logic combining section and outputting the selected one as a coordinate XP; and a second MUX for selecting one of the coordinate YL and an output signal from the adder in response to an output signal from the logic combining section and outputting the selected one as a coordinate YP; wherein the coordinates XL and YL are coordinates on a window W1 of a logical display memory, the coordinates Xₘ and Yₘ are coordinates of the main display panel having a screen size of _{Xm}×Yₘ, the coordinate Xₛ is a coordinate of the sub display panel W2 having a screen size of Xₛ×Yₛ, and the coordinates XP and YP are coordinates of a physical video memory which correspond to the coordinates XL and YL on the window W1 of the logical display memory.

According to yet still another aspect of the present invention, the window read/write circuit section comprises a first subtracter for receiving a coordinate Xe and a coordinate Xb; a first register for storing an output signal of the first subtracter; a first adder for receiving an output signal of the first register and adding one by one; a second subtracter for receiving a coordinate Ye and a coordinate Yb; a second register for storing an output signal of the second subtracter; a second adder for receiving an output signal of the second register and adding one by one; a multiplexer for selecting one of output signals from the first and second adders; a third register for storing an output signal of the multiplexer; a control logic part for receiving an output signal of the third register, a clock signal and a read/write command signal; a counter circuit part for receiving an output signal of the control logic part; a modifier for receiving output signals of the first register and the counter circuit part; a divider for receiving output signals of the first register and the counter circuit part; a third adder for receiving an output signal of the modifier and the coordinate Xb and generating the coordinate XL; and a fourth adder for receiving an output signal of the divider and the coordinate Yb and generating the coordinate YL; wherein the coordinates Xb and Yb and Xe and Ye are coordinates on a window of the logical display memory, the coordinates XL and YL are coordinates on the window of the logical display memory, and inequalities Xe>Xb and Ye>Yb are satisfied.

### BRIEF DESCRIPTION OF THE DRAWINGS

The foregoing and other objects, features and advantages of the present invention will become more apparent from the following detailed description when taken in conjunction with the accompanying drawings in which:

FIGS. 1 through 3 are views illustrating outer appearances of a portable terminal having a dual display panel according to the conventional art, wherein FIG. 1 is a perspective view illustrating the outer appearance of the folded portable terminal, FIG. 2 is a perspective view illustrating the outer appearance of the unfolded portable terminal viewed from the outside, and FIG. 3 is a perspective view illustrating the outer appearance of the unfolded portable terminal viewed from the inside;

FIG. 4 is a block diagram illustrating a display module of the portable terminal having a dual display panel according to the conventional art;

FIGS. 5 through 8 are views illustrating outer appearances of a portable terminal having a single extended screen formed by a dual display panel in accordance with an embodiment of the present invention, wherein FIG. 5 is a perspective view illustrating the outer appearance of the folded portable terminal, FIG. 6 is a perspective view illustrating the outer appearance of the unfolded portable terminal viewed from the outside, FIG. 7 is a perspective view illustrating the outer appearance of the unfolded portable terminal viewed from the inside, and FIG. 8 is a perspective view illustrating the outer appearance of the folded portable terminal with a sub display panel unfolded;

FIGS. 9 through 11 are views illustrating a structure of the sub display panel which is coupled to a folder of the portable terminal by hinges, wherein FIG. 9 is a perspective view illustrating the unfolded sub display panel, FIG. 10 is a transverse cross-sectional view illustrating the unfolded sub display panel, and FIG. 11 is a transverse cross-sectional view illustrating the folded sub display panel;

FIG. 12 is a block diagram illustrating a display module of the portable terminal having a single extended screen formed by a dual display panel according to the present invention;

FIG. 13 is a block diagram illustrating an inner construction of a controller shown in FIG. 12;

FIG. 14 is of views for explaining data mapping operation of a logical/physical mapping circuit section shown in FIG. 13, wherein (a) is a view illustrating a logical display memory and (b) is a view illustrating a physical display memory;

FIGS. 15 through 20 are views illustrating various configurations of the logical display memory depending upon a position where the sub display panel is mated with a main display panel when the sub display panel is unfolded, wherein FIGS. 15 through 17 are views illustrating the configurations in which the sub display panel is mated with the right side of the main display panel, and FIGS. 18 through 20 are views illustrating the configurations in which the sub display panel is mated with the left side of the main display panel;

FIG. 21 is a block diagram illustrating the logical/physical mapping circuit section shown in FIG. 13;

FIG. 22 is a view for explaining a method for constructing windows when forming an extended screen according to the present invention;

FIG. 23 is a block diagram illustrating a window read/write circuit section shown in FIG. 13;

FIG. 24 is a view illustrating a physical video memory for explaining operation of an XY converting logic section shown in FIG. 13;

FIGS. 25 and 26 are views for explaining a window using method according to the present invention, wherein FIG. 25 is a view for explaining a method for using the main display panel and the sub display panel which are integrated with each other to form a single extended screen, and FIG. 26 is an example of constructing a window capable of accomplishing a maximum aspect ratio of 16:9;

FIGS. 27 through 29 are views for explaining a method of arranging main icons and sub icons according to the present invention, wherein FIG. 27 is a view illustrating a shape of the conventional display panel which is in an extended screen mode, FIG. 28 is a view illustrating a shape of a display panel according to the present invention which is in an extended screen mode, and FIG. 29 is a view illustrating a shape of another display panel according to the present invention which is in an extended screen mode;

FIGS. 30 through 33 are views illustrating icons according to the present invention, wherein FIG. 30 is a view illustrating icons according to the conventional art, FIG. 31 is a view illustrating the icons which are shown in FIG. 30 and rotated by 180°, FIG. 32 is a view illustrating icons according to the present invention, and FIG. 33 is a view illustrating the icons which are shown in FIG. 32 and rotated by 180°; and

FIGS. 34 and 35 are views illustrating functional icons according to the present invention, wherein FIG. 34 is a view illustrating an example in which the functional icons according to the present invention are used in a main display panel, and FIG. 35 is a view illustrating an example in which the functional icons according to the present invention are used in a sub display panel.

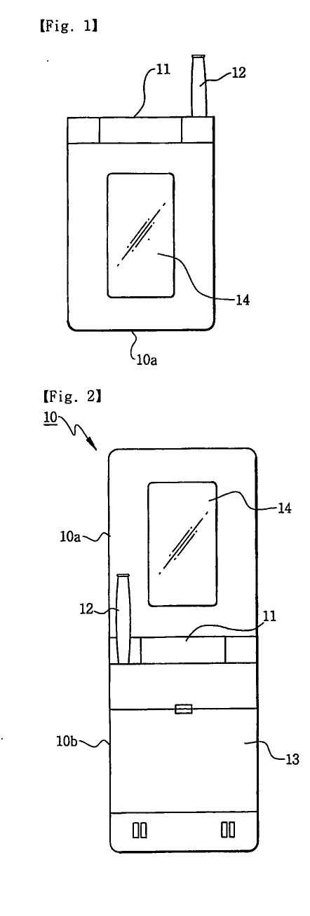

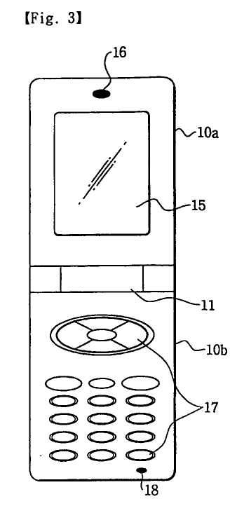

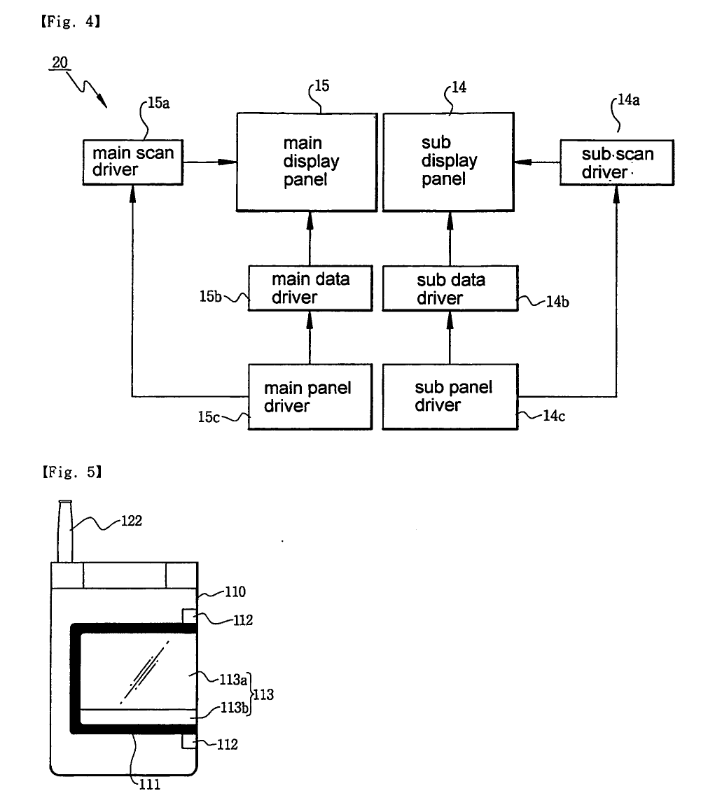

### BEST MODE FOR CARRYING OUT THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

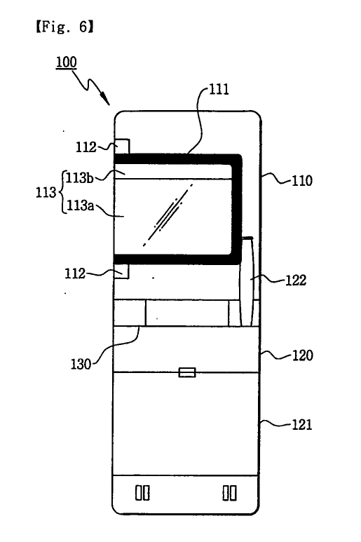

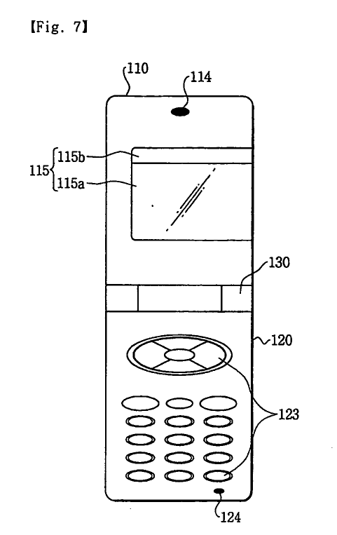

FIGS. 5 through 8 are views illustrating outer appearances of a portable terminal having a single extended screen formed by a dual display panel in accordance with an embodiment of the present invention, wherein FIG. 5 is a perspective view illustrating the outer appearance of the folded portable terminal, FIG. 6 is a perspective view illustrating the outer appearance of the unfolded portable terminal viewed from the outside, FIG. 7 is a perspective view illustrating the outer appearance of the unfolded portable terminal viewed from the inside, and FIG. 8 is a perspective view illustrating the outer appearance of the folded portable terminal with a sub display panel unfolded.

As shown in FIGS. 5 through 8, a portable terminal 100 comprises a folder 110 and a body 120. The folder 110 and the body 120 are coupled to each other by hinges 130 to be folded and unfolded about the hinges 130.

On the inside of the folder 110, there are provided a main display panel 115 serving as a liquid crystal display screen and an earphone 114. On the outside of the folder 110, a sub display panel body 111 which has a sub display panel 113 serving as a liquid crystal display screen is coupled to the folder 110 by hinges 112 to be folded and unfolded about the hinges 112. On the inside of the body 120, there are provided a keypad 123 including various function keys and number keys and a microphone 124, and on the outside of the body 120, there are provided a battery 121 and an antenna 122.

As can be readily seen from FIG. 8, the portable terminal 100 is constructed in a manner such that, when the sub display panel body 111 is unfolded, the main display panel 115 and the sub display panel 113 are mated with each other without creating a substantial gap between them. That is to say, the sub display panel 113 is constructed in a manner such that its LCD screen reaches an edge of the sub display panel body 111, and the main display panel 115 is constructed in a manner such that its LCD screen reaches an edge of the folder 110 which corresponds to the edge of the sub display panel body 111.

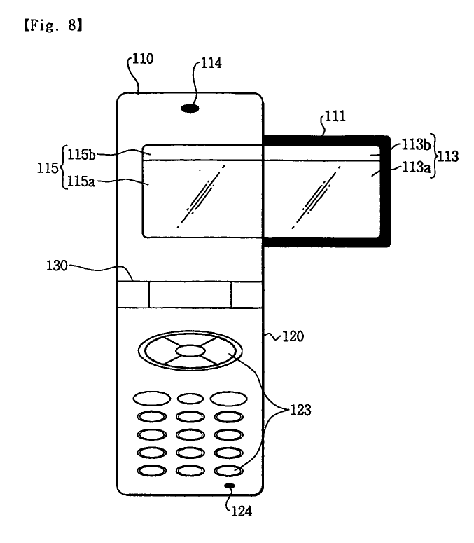

The hinges 112 for allowing the sub display panel 113 to be folded and unfolded with respect to the folder 110 are installed at both ends of one side of the sub display panel 113. A construction and a function of the hinges 112 will be described later in detail with reference to FIGS. 9 through 11.

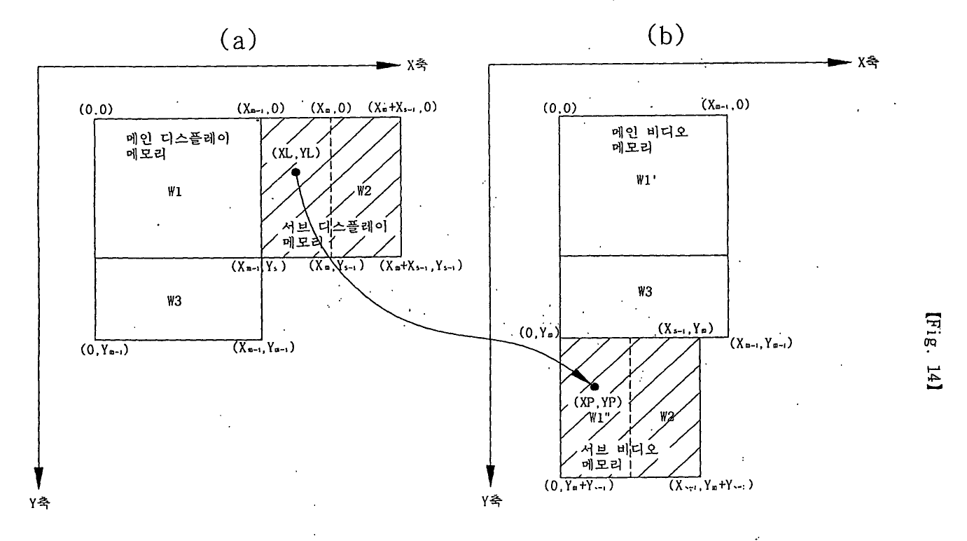

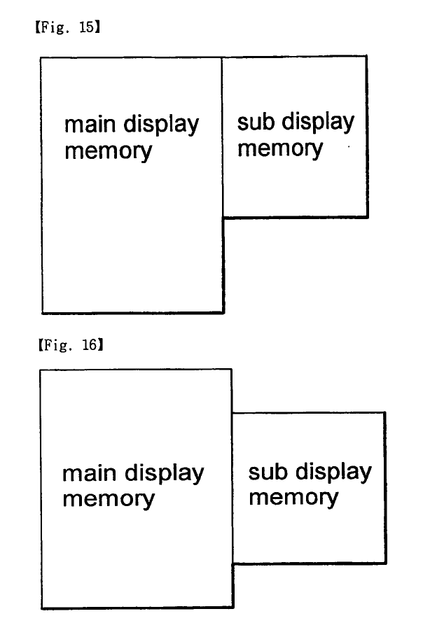

The main display panel 115 comprises a main display panel region 115a and a main icon region 115b. The sub display panel 113 comprises a sub display panel region 113a and a sub icon region 113b. Referring to FIG. 8, the main display panel 115 and the sub display panel 113 are configured in a manner such that, when the sub display panel 113 is unfolded, the main icon region 115b and the sub icon region 113b are positioned in the same direction. Constructions and functions of the main icon region 115b and the sub icon region 113b will be described later in detail with reference to FIGS. 15 through 17.

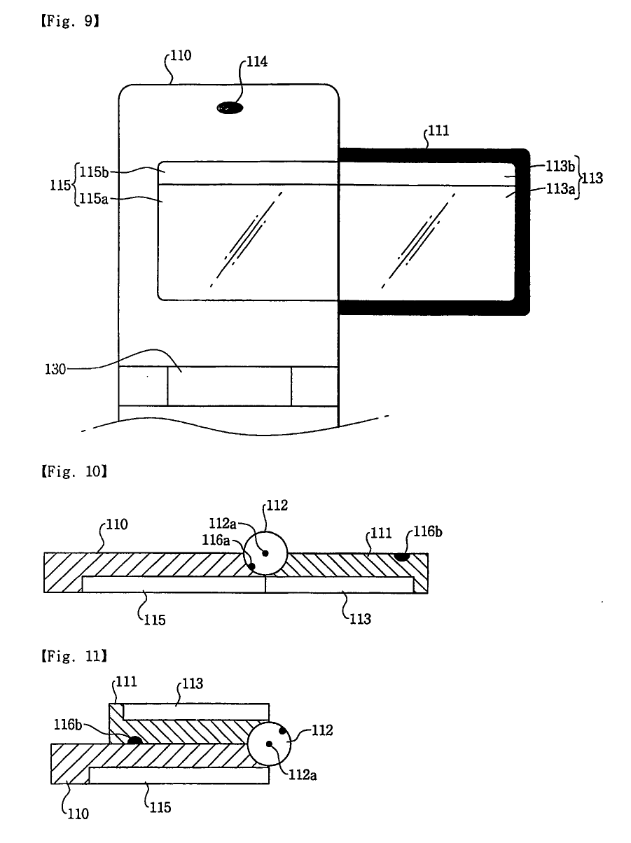

FIGS. 9 through 11 are views illustrating a structure of the sub display panel which is coupled to the folder of the portable terminal by the hinges, wherein FIG. 9 is a perspective view illustrating the unfolded sub display panel, FIG. 10 is a transverse cross-sectional view illustrating the unfolded sub display panel, and FIG. 11 is a transverse cross-sectional view illustrating the folded sub display panel.

As can be readily seen from FIGS. 9 through 11, the folder type portable terminal 100 having a dual display panel is constructed such that, when the sub display panel 113 is unfolded, the main display panel 115 and the sub display panel 113 form a single screen having no substantial gap thereon. To this end, the sub display panel body 111 is coupled to the folder 110 by the hinges 112 such that the sub display panel 113 can be folded and unfolded about the hinges 112 with respect to the folder 110. At this time, the hinges 112 are installed at both ends of one side of the sub display panel 113 such that, when the sub display panel 113 is unfolded, the main display panel 115 and the sub display panel 113 form the single screen having no substantial gap thereon.

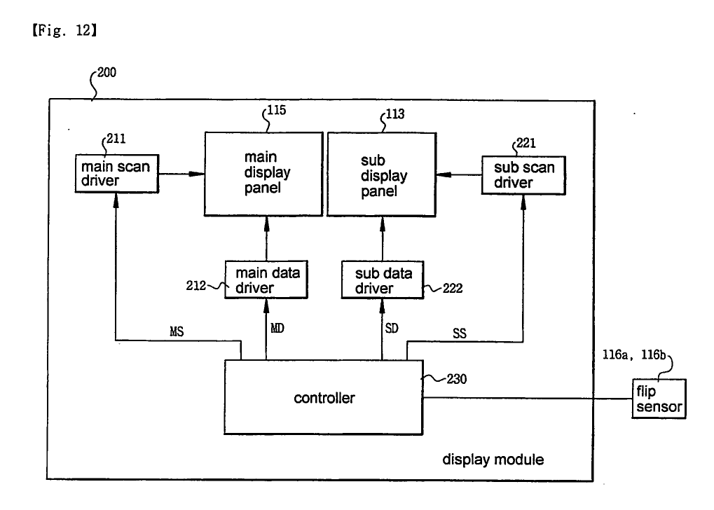

Further, as shown in FIGS. 10 and 11, in the folder type portable terminal 100 having a dual display panel, flip sensors 116a and 116b for sensing folded and unfolded states of the sub display panel 113 are respectively provided to a side of the hinge 112 and a side of the sub display panel body 111. At this time, the side of the sub display panel body 111 means an opposite surface on which the sub display panel 113 is not installed. Functions of the flip sensors 116a and 116b will be described later in detail with reference to FIG. 12.

FIG. 12 is a block diagram illustrating a display module of the portable terminal having a single extended screen formed by a dual display panel according to the present invention.

As shown in FIG. 12, the display module 200 comprises the main display panel 115, a main scan driver 211, a main data driver 212, the sub display panel 113, a sub scan driver 221, a sub data driver 222, and a controller 230.

In the main display panel 115, a plurality of row lines and a plurality of column lines are constructed in the shape of a matrix to define a plurality of pixels. Operation of the main display panel 115 is controlled by, the main scan driver 211 and the main data driver 212.

The main scan driver 211 is connected to the row lines (arranged on a Y axis) of the main display panel 115 and implements scanning operation for sequentially selecting the row lines. At this time, among the pixels connected to the selected row lines, only those pixels which correspond to the column lines (arranged on an X axis) to which image data are applied emit lights.

The main data driver 212 is connected to the column lines (arranged on the X axis) of the main display panel 115. The main data driver 212 converts image data to be displayed into a voltage or a current, and then applies the converted voltage or current to the main display panel 115. The main data driver 212 stores data which correspond to the number of column lines and applies an image data signal to the main display panel 115 each time the row line is selected.

In the sub display panel 113, a plurality of row lines and a plurality of column lines are constructed in the shape of a matrix to define a plurality of pixels. Operation of the sub display panel 113 is controlled by the sub scan driver 221 and the sub data driver 222.

The sub scan driver 221 is connected to the row lines (arranged on a Y axis) of the sub display panel 113 and implements scanning operation for sequentially selecting the row lines. At this time, among the pixels connected to the selected row lines, only those pixels which correspond to the column lines (arranged on an X axis) to which image data are applied emit lights.

The sub data driver 222 is connected to the column lines (arranged on the X axis) of the sub display panel 113. The sub data driver 222 converts image data to be displayed into a voltage or a current, and then applies the converted voltage or current to the main display panel 115. The sub data driver 222 stores data which correspond to the number of column lines and applies an image data signal to the sub display panel 113 each time the row line is selected.

The controller 230 controls the main display panel 115 and the sub display panel 113 in a manner such that, as the sub display panel 113 is folded or unfolded, only the main display panel 115 operates (an independent screen mode) or the main display panel 115 and the sub display panel 113 operate to form the single extended screen (an cooperating screen mode). Hereafter, a construction and a function of the controller 230 will be described with reference to FIG. 13.

FIG. 13 is a block diagram illustrating an inner construction of the controller shown in FIG. 12.

As shown in FIG. 13, the controller 230 comprises a window read/write circuit section 231 for reading and writing window data from and to a main system 240 of the portable terminal; a main video memory 233 for storing main scan data signals MS and main image data signals MD for driving the main display panel 115; a sub video memory 235 for storing sub scan data signals SS and sub image data signals SD for driving the sub display panel 113; a logical/physical mapping circuit section 232 for logically or physically mapping data transmitted between the main video memory 233 and the sub video memory 235 and the window read/write circuit section 231; an XY converting logic section 236 for XY-converting and outputting the sub scan data signals SS and the sub image data signals SD stored in the sub video memory 235, in response to a signal received from the flip sensors 116a and 116b; a main scan/data interface section 234 for transmitting the main scan data signals MS and the main image data signals MD stored in the main video memory 233 to the main scan driver 211 and the main data driver 212; and a sub scan/data interface section 237 for transmitting the sub scan data signals SS and the sub image data signals SD received from the XY converting logic section 236 to the sub scan driver 221 and the sub data driver 222.

The controller 230 constructed as described above implements a control task such that, in response to a signal received from the flip sensors 116a and 116b, the main display panel 115 and the sub display panel 113 independently operate (the independent screen mode) or the main display panel 115 and the sub display panel 113 cooperate to form the single extended screen (the cooperating screen mode).

In other words, if the signal received from the flip sensors 116a and 116b is a signal which senses the folded state of the sub display panel 113, operation of the main scan driver 211 and the main data driver 212 is controlled such that only the main display panel 115 operates.

If the signal received from the flip sensors 116a and 116b is a signal which senses the unfolded state of the sub display panel 113, operation of the main and sub scan drivers 211 and 221 and the main and sub data drivers 212 and 222 is controlled such that the main display panel 115 and the sub display panel 113 cooperate to form the single screen.

At this time, since a screen of the sub display panel 113 should be displayed in a state in which it is rotated by 180°, the controller 230 implements a control task such that the sub scan data signal to be transmitted to the sub scan driver 221 and the sub image data signal to be transmitted to the sub data driver 222 are XY-converted by the XY converting logic section 236 and then transmitted to the sub scan driver 221 and the sub data driver 222, respectively.

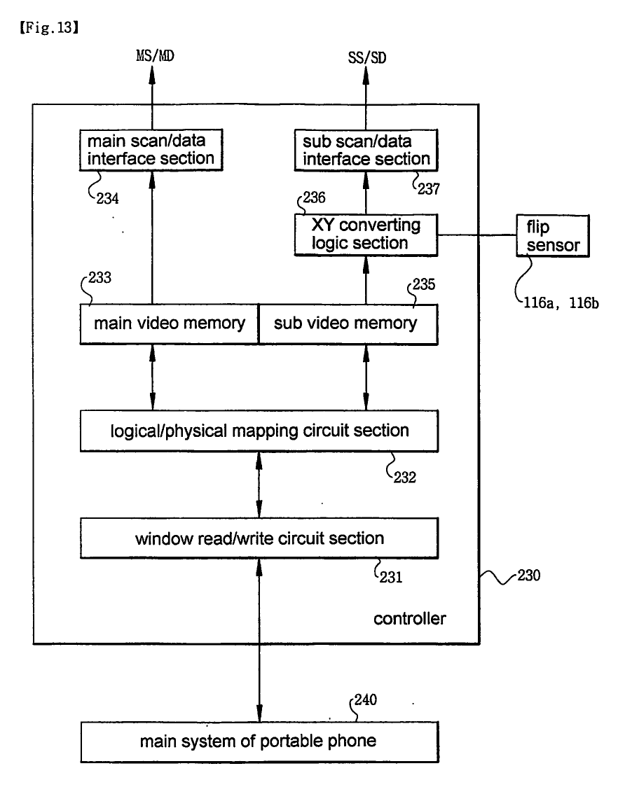

FIG. 14 is of views for explaining data mapping operation of the logical/physical mapping circuit section 232 shown in FIG. 13, wherein (a) is a view illustrating a logical display memory and (b) is a view illustrating a physical display memory.

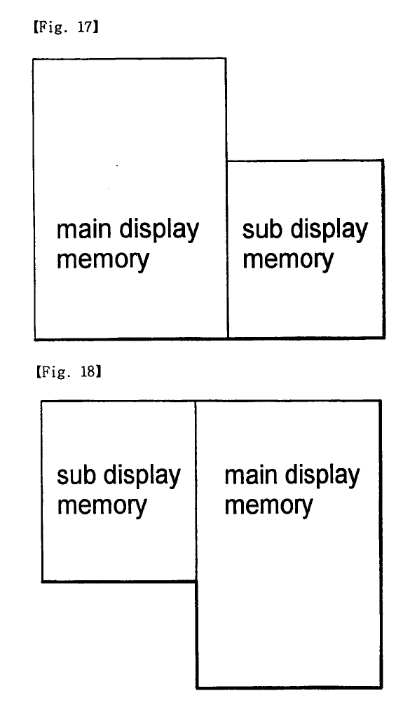

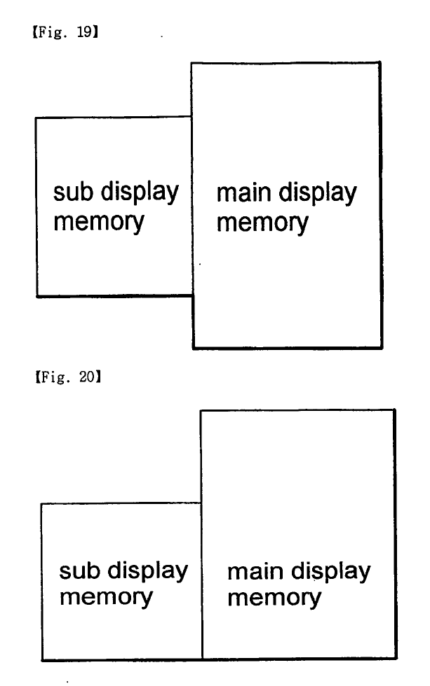

FIGS. 15 through 20 are views illustrating various configurations of the logical display memory depending upon a position where the sub display panel is mated with a main display panel when the sub display panel is unfolded, wherein FIGS. 15 through 17 are views illustrating the configurations in which the sub display panel is mated with the right side of the main display panel, and FIGS. 18 through 20 are views illustrating the configurations in which the sub display panel is mated with the left side of the main display panel.

Hereinbelow, a display memory viewed in the standpoint of a system or a programmer is called a logical display memory, and a display memory viewed in the standpoint of a hardware actually configured by an SRAM, etc. is called a physical display memory.

Hereinafter, data mapping operation of the logical/physical mapping circuit section 232 will be described with reference to FIGS. 14(a) and 14(b).

When representing coordinates of the screen of the logical display memory (a) using the Cartesian coordinate system, the main display panels W1 and W3 having a screen size of Xₘ×Yₘ has a rectangular shape which possesses coordinates (0,0) and (Xₘ₋₁,Yₘ₋₁), and the sub display panel W2 having a screen size of Xₛ×Yₛ has a square shape which possesses coordinates (0,0) and (Xₛ₋₁, Yₛ₋₁).

These shapes of the main display memory and the sub display memory can be combined to define various configurations as shown in FIGS. 15 through 20. In this regard, the configuration shown in FIG. 14 will be described as an example since it is most practical and easy to understand.

As shown in FIG. 14(a), the logical display memory which is viewed in the standpoint of a system or a programmer defines a polygon which is delimited by straight lines connecting coordinates (0,0), (Xₘ+Xₛ₋₁,0), (Xₘ+Xₛ₋₁,Yₛ₋₁), (Xₘ,Yₛ₋₁), (Xₘ₋₁,Yₛ), (Xₘ₋₁,Yₘ₋₁) and (0,Yₘ₋₁).

However, each of the main video memory 233 and the sub video memory 235 each of which is composed of a dual port SRAM for storing actual image data, etc. comprises a physical video memory as shown in FIG. 14(b), due to hardware limitations induced when driving scan modules and data modules of the main display panel 115 and the sub display panel 113. Namely, the physical video memory is composed of a main video memory W1′ and W3 designated by the reference numeral 233 which has a rectangular shape possessing coordinates (0,0) and (Xₘ₋₁,Yₘ₋₁), and a sub video memory W1″ and W2 designated by the reference numeral 235 which has a square shape possessing coordinates (0,Yₘ) and (X_{S-1},Yₘ+Yₛ₋₁).

At this time, when assuming that the coordinates viewed in the standpoint of a programmer are coordinates (XL,YL) of the window W1 of the logical display memory (see FIG. 14(a)) and the corresponding coordinates of the video memory of the physical video memory (see FIG. 14(b)) are (XP,YP), in the example shown in FIG. 14, the window W1 on the logical display memory (a) is divided into two windows W1′ and W1″ on the physical video memory (b), and the coordinates (XP,YP) are placed on the window W1″.

The coordinates (XL,YL) of the logical display memory (a) are mapped into the coordinates (XP,YP) on the physical display memory (b), by the following equations.

[Equation 1]
i) If 0=XL=Xₘ, XP=XL and YP=YL
ii) If Xₘ<XL≦Xₛ, XP=XL−Xₘ and YP=YL+Yₘ

This can be effected by the hardware shown in the block diagram of FIG. 21.

FIG. 21 is a block diagram illustrating the logical/physical mapping circuit section 232 shown in FIG. 13.

As shown in FIG. 21, the logical/physical mapping circuit section 232 comprises a subtracter 301 for receiving a coordinate XL and a coordinate Xₘ and implementing subtracting operation; an adder 302 for receiving a coordinate YL and a coordinate Yₘ and implementing adding operation; a first comparator 303 for receiving the coordinate XL and a coordinate 0 and comparing them with each other; a second comparator 304 for receiving the coordinate XL and the coordinate Xₘ and comparing them with each other; a third comparator 305 for receiving the coordinate XL and a coordinate Xₘ+Xₛ and comparing them with each other; a logic combining section 306 for receiving and logically combining output signals from the first through third comparators 303 through 305; a first MUX 307 for selecting one of the coordinate XL and an output signal from the subtracter 301 in response to an output signal from the logic combining section 306 and outputting the selected one as a coordinate XP; and a second MUX 308 for selecting one of the coordinate YL and an output signal from the adder 302 in response to an output signal from the logic combining section 306 and outputting the selected one as a coordinate YP. Here, the coordinates (XL,YL) are coordinates on the window W1 of the logical display memory (a) (see FIG. 14), and the coordinates (Xₘ,Yₘ) are coordinates of the main display panel having a screen size of Xₘ×Yₘ. The coordinates (Xₛ,Yₛ) are coordinates of the sub display panel W2 having a screen size of Xₛ×Yₛ, and the coordinates (XP,YP) are coordinates of the physical video memory (b) which correspond to the coordinates (XL,YL) on the window W1 of the logical display memory (a).

The logical display memory having a large screen constructed as shown in FIG. 14(a) can be used in a state in which it is divided into a plurality of screen parts each called a window.

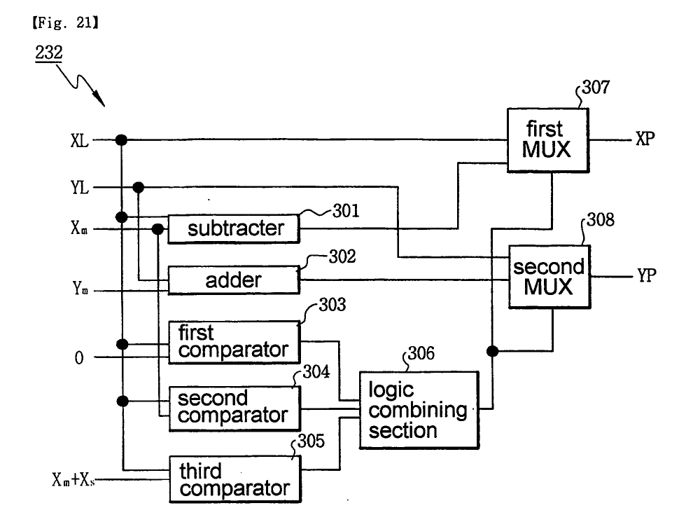

FIG. 22 is a view for explaining a method for constructing windows when forming an extended screen according to the present invention.

Before explaining the window constructing method, it is necessary to define simple operators as described below.

Theorem 1: When assuming that a and b are integers and b>0, the following unique integers q and r exist.

[Equation 2]
a=bq+r, 0=r b

When X is a real, [X] represents a maximum integer which is no greater than X.

Theorem 2: Then, q=[a/b], and r=a−b[a/b]

Here, /means division.

Definition 1: An operator a Div(b) is defined as described below:
q=a Div(b)

Definition 2: An operator Mod(a/b) is defined as described below:
r=a Mod(b)

As shown in FIG. 22, one rectangular window can be expressed by coordinates (Xb,Yb) and (Xe,Ye) in the Cartesian coordinate system. Here, Xe>Xb and Ye>Yb. While the respective windows can be constructed in a manner such that they are superposed on one another on the logical display memory to have an optional size, for the sake of clarity in explaining operation, an example will be taken, in which a plurality of windows are constructed in the form of a title in a manner such that they are not superposed on one another.

A sequence of reading and writing operation in a logical display memory is as described below:

1. Starting coordinates (Xbi,Ybi) and (Xei,Yei) of each window Wi are determined,

2. A window to be activated and Wk are selected among a plurality of windows, and

3. The number of data NWk is obtained as follows, and reading and writing operation is implemented through the number of times which corresponds to the number of data.
NWk=, =(Xek−Xbk+1)×(Yek−Ybk+1)

Here, (Xbk,Ybk) and (Xek,Yek) indicate starting and ending coordinates of the window Wk in the XY Cartesian coordinate system.

This operation is implemented in synchronism with reading/writing digital clocks as follows.

C=0: Initialization of a read/write counter

NX=Xe−Xb: A size of the window on the X axis

NY=Ye−Yb: A size of the window on the Y axis

NWk=(NX+1)*(NY+1): The number of entire data

For each clock to be read and written, and until C becomes NWk

(

XL=Xb+C Mod(NX) ;
YL=Yb+C Div(NX) ; and
C=C+1;

)

A hardware version of these operation is shown in FIG. 23. Here, a modifier and a divider can be embodied in a diversity of ways by two complementary subtracters, etc.

FIG. 23 is a block diagram illustrating the window read/write circuit section 231 shown in FIG. 13.

The window read/write circuit section 231 comprises a first subtracter 401 for receiving a coordinate Xe and a coordinate Xb; a first register 402 for storing an output signal of the first subtracter 401; a first adder 403 for receiving an output signal of the first register 402 and adding one by one; a second subtracter 404 for receiving a coordinate Ye and a coordinate Yb; a second register 405 for storing an output signal of the second subtracter 404; a second adder 406 for receiving an output signal of the second register 405 and adding one by one; a multiplexer 407 for selecting one of output signals from the first and second adders 403 and 406; a third register 408 for storing an output signal of the multiplexer 407; a control logic part 409 for receiving an output signal of the third register 408, a clock signal CLK and a read/write command signal Read/Write; a counter circuit part 410 for receiving an output signal of the control logic part 409; a modifier 411 for receiving output signals of the first register 402 and the counter circuit part 410; a divider 412 for receiving output signals of the first register 402 and the counter circuit part 410; a third adder 413 for receiving an output signal of the modifier 411 and the coordinate Xb and generating the coordinate XL; and a fourth adder 414 for receiving an output signal of the divider 412 and the coordinate Yb and generating the coordinate YL.

Here, the coordinates (Xb,Yb) and (Xe,Ye) are coordinates on a window of the logical display memory, the coordinates (XL,YL) are coordinates on the window of the logical display memory, and inequalities Xe>Xb and Ye>Yb are satisfied.

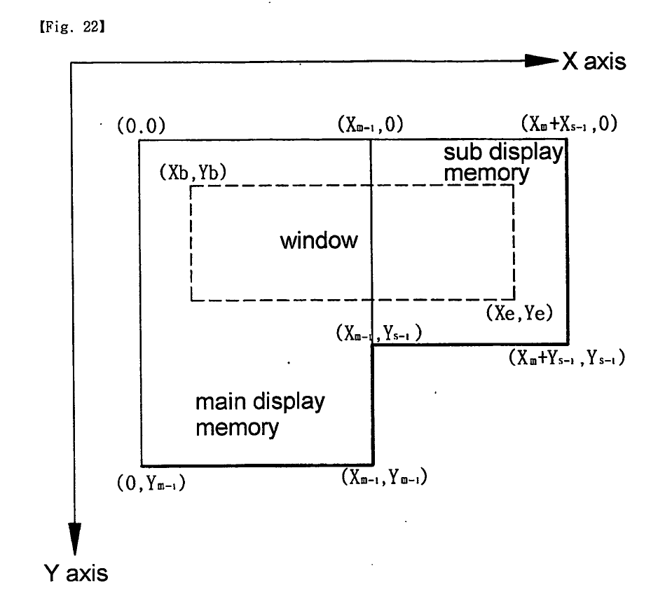

FIG. 24 is a view illustrating the physical video memory for explaining operation of the XY converting logic section shown in FIG. 13.

When realizing the independent screen mode and the cooperating screen mode, the screen shape of the sub display panel should be rotated by 180 degrees. As shown in FIG. 24, when the coordinates of the physical video memory are given, in the case of the independent screen mode, a sequence of data which are applied to the sub data driver 222 to drive the sub display panel 113 is as follows.

(0,Yₘ), (1,Yₘ) . . . , (Xₛ₋₁,Yₘ)

(0,Yₘ₊₁), (1,Yₘ₊₁) . . . , (Xₛ₋₁,Yₘ₊₁)

. . .

(0,Yₘ+Yₛ₋₁), (1,Yₘ+Yₛ₋₁) . . . , (Xₛ₋₁,Yₘ+Yₛ₋₁)

In the case of the cooperating screen mode, a sequence of the independent screen mode is reversed as follows.

(Xₛ₋₁,Yₘ+Yₛ₋₁) . . . , (0,Yₘ+Yₛ₋₁), (1,Yₘ+Yₛ₋₁)

. . .

(Xₛ₋₁,Yₘ₊₁), (1, Yₘ₊₁) . . . , (0,Yₘ₊₁)

(Xₛ₋₁,Yₘ) . . . , (1,Yₘ), (0,Yₘ)

A correlation between the coordinates (Xk,Yk) of the independent screen mode and the coordinates (Xt,Yt) of the cooperating screen mode can be expressed by a function as follows:
Xt=(Xₛ₋₁)−Xk
Yt=(Yₘ+Yₛ₋₁)−Yk

Since this circuit can be formed by simple adding and subtracting circuits, its illustration is omitted herein.

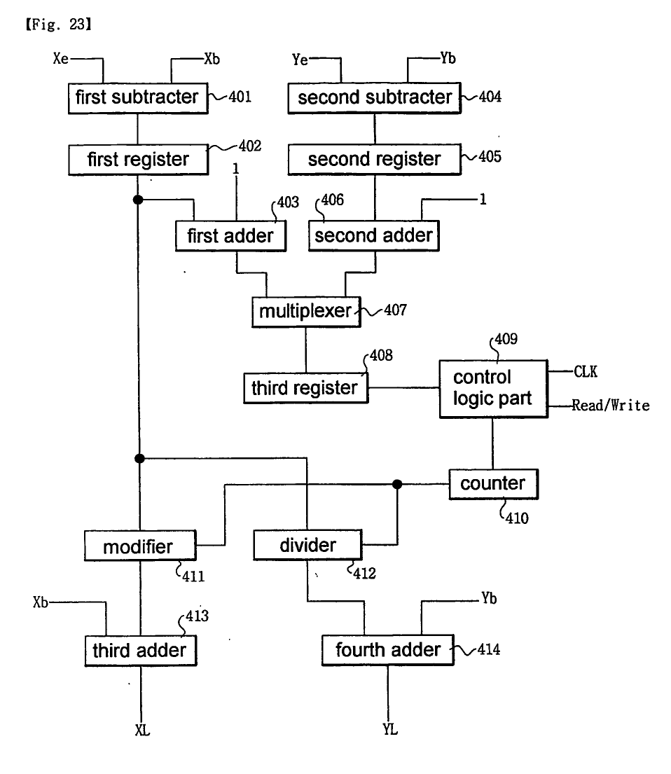

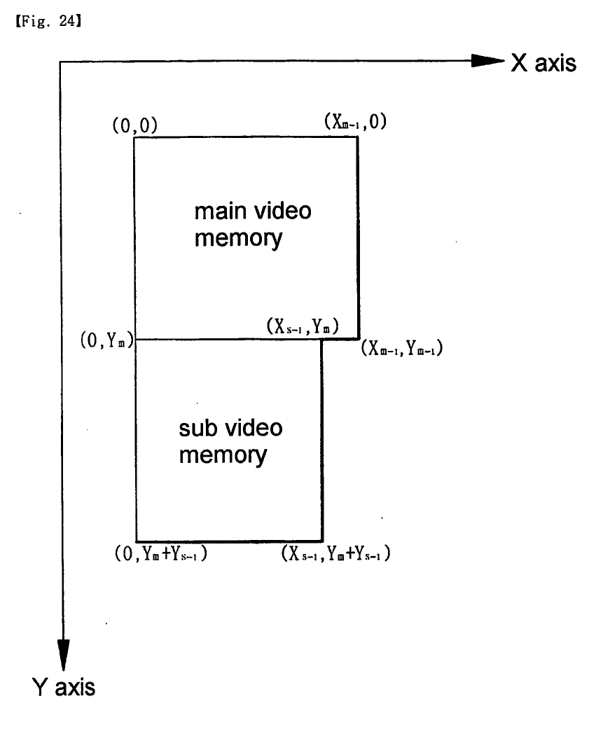

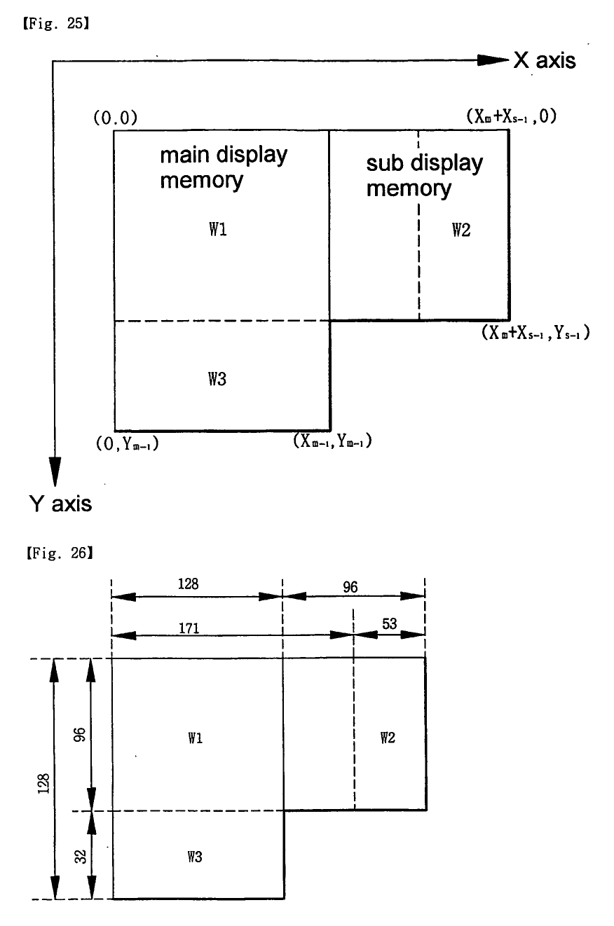

FIGS. 25 and 26 are views for explaining a window using method according to the present invention, wherein FIG. 25 is a view for explaining a method for using the main display panel and the sub display panel which are integrated with each other to form a single extended screen, and FIG. 26 is an example of constructing a window capable of accomplishing a maximum aspect ratio of 16:9.

1. A method of using the main/sub display panels cooperating with each other to form the single extended screen

In a method for effectively constructing a window constituting a large screen in the logical display memory shown in FIG. 25, the main window W1 is formed to have a large aspect ratio of 16:9, that is, (Xₘ+Xₛ):Yₛ=16:9, and then, a plurality of windows such as the first sub window W2 and the second sub window W3 are sequentially formed. At this time, when considering one application example, a multi-media moving picture having an aspect ratio of 16:9 is displayed on the main window, and the first and second sub windows W2 and W3 can be employed to display translated dialogues or communication information of a portable terminal (for example, a messenger massage, and so forth).

In one example, when the main display panel 115 has a size of 128×128 and the sub display panel 113 has a size of 96×96, three windows having sizes of 171×96, 53×96 and 128×32 can be constructed as shown in FIG. 26.

For reference, when considering a characteristic of a digital logic circuit, a hardware can be more easily constructed when the window have even-numbered sizes such as 170×96, 54×96 and 128×32.

2. A method for forming a window having an aspect ratio of 16:9

When considering the fact that a portable terminal has a small size, since a size of an integrated screen is relatively smaller than other electronic appliances, in order to form a main window having a large window size of 16:9 aspect ratio and a reduced number of window elements, it is most preferable to use one main window and one sub window. Here, it is assumed that the main display panel 115 has a size greater than that of the sub display panel 113.

When assuming that the main display panel 115 has a size of Xₘ×Yₘ and the sub display panel 113 has a size of Xₛ×Yₛ, the following correlations are established.
(Xₘ+Xₛ):Yₛ=16:9
Yₛ=9(X_{m+X}ₛ)/16

Here, Xₘ>Xₛ and Yₘ>Yₛ.

When considering CIF and VGA which define standards for a main display panel, standards for a sub display panel which can be used to effectively construct the main display panel having an aspect ratio of 16:9 are given in Table 1.

TABLE 1

| Standards for main display | Standards for sub display |
|---|---|
| panel | panel suitable for 16:9 |
| 128 × 128 | 108 × 128 |
| 128 × 160 | 158 × 160 |
| | 100 × 128 (disqualified) |
| 176 × 144 | 80 × 144 |
| 160 × 120 | 54 × 120 |
| 320 × 240 | 108 × 240 |
| 640 × 480 | 216 × 480 |

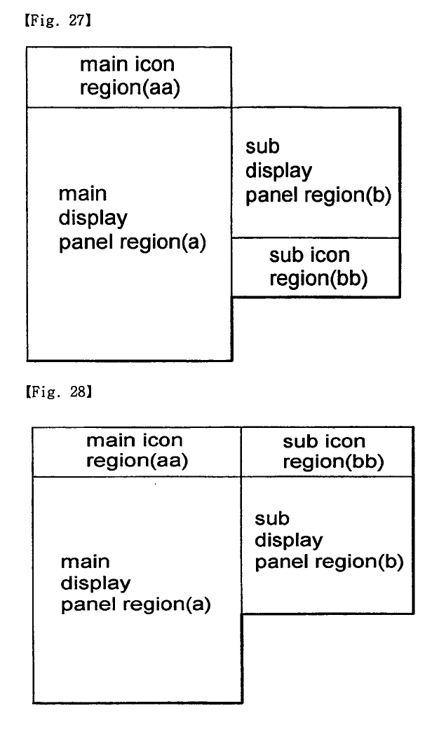

FIGS. 27 through 29 are views for explaining a method of arranging main icons and sub icons according to the present invention, wherein FIG. 27 is a view illustrating a shape of the conventional display panel which is in an extended screen mode, FIG. 28 is a view illustrating a shape of a display panel according to the present invention which is in an extended screen mode, and FIG. 29 is a view illustrating a shape of another display panel according to the present invention which is in an extended screen mode.

When the single extended screen is formed, the sub display panel is rotated by 180° and connected to the main display panel. At this time, a screen position of the sub display panel is changed in longitudinal and transverse directions. Icons of the sub display panel which are positioned at an upper end of the screen in the independent screen mode are changed in their shapes in the longitudinal and transverse directions and are positioned at a lower end of the single extended screen as shown in FIG. 27.

Accordingly, due to the fact that the icons of the sub display panel which are positioned at the upper end of the screen in the independent screen mode are positioned lower in the single extended screen in the cooperating screen mode, it is possible to arrange the icons in an integrated pattern as shown in FIG. 28, whereby the icons can be conveniently used.

Similarly, when the icons of the main display panel are positioned at a lower end of the main display panel, it is preferred that the icons of the sub display panel be positioned at a lower end of the sub display panel as shown in FIG. 29 in the independent screen mode.

Meanwhile, as shown FIGS. 18 through 20, even when the hinges are positioned at a left side and the sub display panel is unfolded leftward, the same method as described above can be used.

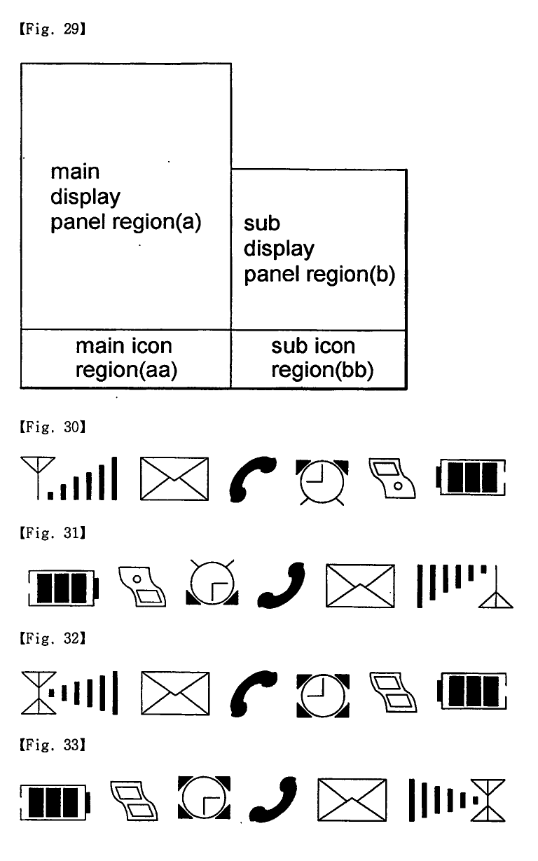

FIGS. 30 through 33 are views illustrating icons according to the present invention, wherein FIG. 30 is a view illustrating icons according to the conventional art, FIG. 31 is a view illustrating the icons which are shown in FIG. 30 and rotated by 180°, FIG. 32 is a view illustrating icons according to the present invention, and FIG. 33 is a view illustrating the icons which are shown in FIG. 32 and rotated by 180°.

Since the icons of the sub display panel are changed in its shape in the longitudinal and transverse directions, the icons are designed to be symmetrical in longitudinal and transverse directions as shown in FIGS. 32 and 33. Consequently, even when the icons are rotated by 180°, their functional shapes are not changed.

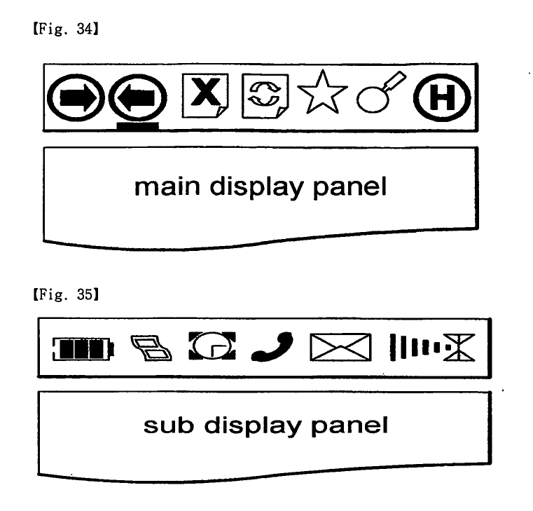

Finally, FIGS. 34 and 35 are views illustrating functional icons according to the present invention, wherein FIG. 34 is a view illustrating an example in which the functional icons according to the present invention are used in a main display panel, and FIG. 35 is a view illustrating an example in which the functional icons according to the present invention are used in a sub display panel.

As can be readily seen from FIG. 35, the conventional icons only serve as simple display means for displaying corresponding functions. However, in the present invention, as shown in FIG. 34, a menu function is provided to the icons by using one of an under bar, a square and a reverse so that a corresponding operation can be implemented.

For example, as shown in FIG. 34, by selecting an icon corresponding to Internet Browser using the under bar, when accessing the Internet using the portable terminal, it is possible to conveniently use the portable terminal as in the Internet Browser on a PC.

### INDUSTRIAL APPLICABILITY

As apparent from the above description, the portable terminal having a single extended screen formed by a dual display panel, and a method and a device for controlling display on the screen, according to the present invention, provide advantages in that two screens constituted by a main display panel and a sub display panel can cooperatively form a single extended large screen.

Also, the two screens constituted by the main display panel and the sub display panel can be combined to form a single integrated screen having no substantial gap between the two screens.

Further, the two screens constituted by the main display panel and the sub display panel can be combined to form a single integrated screen having no substantial gap between the two screens so that an image having a large aspect ratio such as 16:9 can be displayed on the integrated screen.

Moreover, the two screens constituted by the main display panel and the sub display panel can be combined to form a single integrated screen having no substantial gap between the two screens so that an image having a large aspect ratio such as 16:9 and dialogues and additional information such as communication information and the like can be displayed on the integrated screen.

Furthermore, two display controllers for respectively controlling the main display panel and the sub display panel can be embodied in a single chip to thereby enabling optimization of a circuit size and accomplishing a lower power operation characteristic.

Besides, main icons and sub icons can be positioned in the same direction on the single integrated screen constituted by the main display panel and the sub display panel.

In addition, the sub icons can be embodied to accomplish symmetrical arrangement structures in a manner such that the sub icons have the same proper shapes irrespective of operation for folding and unfolding the sub display panel.

Also, the main icons arranged on the single integrated screen constituted by the main display panel and the sub display panel can be embodied as functional icons, to thereby render more functions and more improved user convenience than other portable terminals.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A portable terminal having a dual display panel, comprising:
a body having a plurality of function keys and number keys;
a folder coupled to the body by hinges to be folded and unfolded about the hinges, and having on one surface thereof a main display panel and on the other surface thereof a sub display panel which is coupled to the folder by hinges to be folded and unfolded about the hinges, the folder being capable of providing a single extended screen through cooperation of the main display panel and the sub display panel; and
a display module for controlling the main display panel and the sub display panel such that the main display panel and the sub display panel are independently driven when the sub display panel is folded and are cooperatively driven to form the single extended screen when the sub display panel is unfolded;
the display module comprising:
a main scan driver for sequentially selecting and scanning row lines of the main display panel;
a main data driver for applying image data signals to column lines of the main display panel;
a sub scan driver for sequentially selecting and scanning row lines of the sub display panel;
a sub data driver for applying image data signals to column lines of the sub display panel; and
a controller for implementing a control task such that the main scan driver and the main data driver are driven to operate the main display panel and such that the main scan driver, the main data driver, the sub scan driver and the sub data driver are driven to operate the main display panel and the sub display panel to form the single extended screen;
the controller comprising:
a window read/write circuit section for reading and writing window data from and to a main system of the portable terminal;
a main video memory for storing main scan data signals and main image data signals for driving the main display panel;
a sub video memory for storing sub scan data signals and sub image data signals for driving the sub display panel;
a logical/physical mapping circuit section for logically or physically mapping data transmitted between the main video memory and the sub video memory and the window read/write circuit section;
an XY converting logic section for XY-converting and outputting the sub scan data signals and the sub image data signals stored in the sub video memory, in response to a signal from a flip sensor;
a main scan/data interface section for transmitting the main scan data signals and the main image data signals received from the main video memory to the main scan driver and the main data driver; and
a sub scan/data interface section for transmitting the sub scan data signals and the sub image data signals received from the XY converting logic section to the sub scan driver and the sub data driver.

2. The portable terminal according to claim 1, wherein the folder provides the single extended screen having no substantial gap thereon, through cooperation of the main display panel and the sub display panel.

3. The portable terminal according to claim 1, wherein the main display panel and the sub display panel are formed to extend to an edge of the folder such that no substantial gap is created between the main display panel and the sub display panel when the sub display panel is unfolded.

4. The portable terminal according to claim 1, wherein the single extended screen comprises a window screen having an aspect ratio of 16:9.

5. The portable terminal according to claim 1, further comprising:
a flip sensor for sensing folded and unfolded states of the sub display panel.

6. The portable terminal according to claim 1, wherein at least one of text information including a translated dialogue and communication information of the portable terminal is displayed on a portion of the screen.

7. The portable terminal according to claim 1, wherein an antenna of the portable terminal is installed to be positioned opposite to the hinges by which the sub display panel is coupled to the folder.

8. The portable terminal according to claim 1, wherein main icons configured on the main display panel and sub icons configured on the sub display panel are arranged in the same direction when the sub display panel is unfolded.

9. The portable terminal according to claim 8, wherein a menu function is provided to the main icons by using one of an under bar, a square and a reverse so that a corresponding operation can be implemented.

10. The portable terminal according to claim 8, wherein the sub icons have shapes which are symmetrical in both longitudinal and transverse directions so that expressional functionality of the sub icons is maintained when the sub display panel is unfolded.

11. The portable terminal according to claim 1, wherein each of the main display panel and the sub display panel comprises a flat panel display such as an organic LED and an LCD.

12. The portable terminal according to claim 1, wherein the logical/physical mapping circuit section comprises:
a subtracter for receiving a coordinate XL and a coordinate Xₘ;
an adder for receiving a coordinate YL and a coordinate Yₘ;
a first comparator for receiving the coordinate XL and a coordinate 0;
a second comparator for receiving the coordinate XL and the coordinate Xₘ;
a third comparator for receiving the coordinate XL and a coordinate Xₘ+Xₛ;
a logic combining section for receiving output signals from the first through third comparators;
a first MUX for selecting one of the coordinate XL and an output signal from the subtracter in response to an output signal from the logic combining section and outputting the selected one as a coordinate XP; and
a second MUX for selecting one of the coordinate YL and an output signal from the adder in response to an output signal from the logic combining section and outputting the selected one as a coordinate YP;
wherein the coordinates (XL,YL) are coordinates on a window W1 of a logical display memory, the coordinates Xₘ,Yₘ) are coordinates of the main display panel having a screen size of Xₘ×Yₘ, the coordinates (Xₛ,Yₛ) are coordinates of the sub display panel W2 having a screen size of Xₛ×Yₛ, and the coordinates (XP,YP) are coordinates of a physical video memory which correspond to the coordinates (XL,YL) on the window W1 of the logical display memory.

13. The portable terminal according to claim 1, wherein the window read/write circuit section comprises:
a first subtracter for receiving a coordinate Xe and a coordinate Xb;
a first register for storing an output signal of the first subtracter;
a first adder for receiving an output signal of the first register and adding one by one;
a second subtracter for receiving a coordinate Ye and a coordinate Yb;
a second register for storing an output signal of the second subtracter;
a second adder for receiving an output signal of the second register and adding one by one;
a multiplexer for selecting one of output signals from the first and second adders;
a third register for storing an output signal of the multiplexer;
a control logic part for receiving an output signal of the third register, a clock signal and a read/write command signal;
a counter circuit part for receiving an output signal of the control logic part;
a modifier for receiving output signals of the first register and the counter circuit part;
a divider for receiving output signals of the first register and the counter circuit part;
a third adder for receiving an output signal of the modifier and the coordinate Xb and generating the coordinate XL; and
a fourth adder for receiving an output signal of the divider and the coordinate Yb and generating the coordinate YL;
wherein the coordinates (Xb,Yb) and (Xe,Ye) are coordinates on a window of the logical display memory, the coordinates (XL,YL) are coordinates on the window of the logical display memory, and inequalities Xe>Xb and Ye>Yb are satisfied.

14. A method for controlling display on a screen of a portable terminal having a body which possesses a plurality of function keys and number keys and a folder which is coupled to the body by hinges to be folded and unfolded about the hinges and possesses on one surface thereof a main display panel and on the other surface thereof a sub display panel coupled to the folder by hinges to be folded and unfolded about the hinges, the method comprising the steps of:
controlling by a controller the main display panel and the sub display panel when the sub display panel is folded, such that the main display panel and the sub display panel are independently driven; and
controlling by the controller the main display panel and the sub display panel when the sub display panel is unfolded, such that the main display panel and the sub display panel are cooperatively driven to form a single extended screen having no substantial gap thereon;
wherein the single extended screen comprises a window screen having an aspect ratio of 16:9; and
wherein, when assuming that the main display panel has a size of Xₘ×Yₘ and the sub display panel has a size of Xₛ×Yₛ and when considering an equation for constructing the window screen of 16:9, (Xₘ+Xₛ):Yₛ=16:9, the window screen having the aspect ratio of 16:9 satisfies an inequality (Xₘ+Xₛ)≧16Yₛ/9(Xₘ≧Xₛ and Yₘ≧Yₛ).

15. The method according to claim 14, wherein the main display panel and the sub display panel are formed to extend to an edge of the folder such that no substantial gap is created between the main display panel and the sub display panel when the sub display panel is unfolded to form the single extended screen.

16. The method according to claim 14, wherein at least one of text information including a translated dialogue and communication information of the portable terminal is displayed on a portion of the single extended screen.

17. The method according to claim 14, wherein main icons configured on the main display panel and sub icons configured on the sub display panel are arranged in the same direction when the sub display panel is unfolded to form the single extended screen.

18. The method according to claim 17, wherein a menu function is provided to the main icons by using one of an under bar, a square and a reverse so that a corresponding operation can be implemented.

19. The method according to claim 17, wherein the sub icons have shapes which are symmetrical in both longitudinal and transverse directions so that expressional functionality of the sub icons is maintained when the sub display panel is unfolded to form the single extended screen.

20. A device for controlling display on a screen of a portable terminal having a dual display panel, comprising:
a main scan driver for sequentially selecting and scanning row lines of a main display panel;
a main data driver for applying image data signals to column lines of the main display panel;
a sub scan driver for sequentially selecting and scanning row lines of a sub display panel;
a sub data driver for applying image data signals to column lines of the sub display panel; and
a controller for controlling the drivers such that the main display panel and the sub display panel are independently driven or the main display panel and the sub display panel are cooperatively driven to form a single extended screen;
the controller comprising:
a window read/write circuit section for reading and writing window data from and to a main system of the portable terminal;
a main video memory for storing main scan data signals and main image data signals for driving the main display panel;
a sub video memory for storing sub scan data signals and sub image data signals for driving the sub display panel;
a logical/physical mapping circuit section for logically or physically mapping data transmitted between the main video memory and the sub video memory and the window read/write circuit section;
an XY converting logic section for XY-converting and outputting the sub scan data signals and the sub image data signals stored in the sub video memory, in response to a signal from a flip sensor;
a main scan/data interface section for transmitting the main scan data signals and the main image data signals received from the main video memory to the main scan driver and the main data driver; and
a sub scan/data interface section for transmitting the sub scan data signals and the sub image data signals received from the XY converting logic section to the sub scan driver and the sub data driver.

21. The device according to claim 20, wherein the logical/physical mapping circuit section comprises:
a subtracter for receiving a coordinate XL and a coordinate Xₘ;
an adder for receiving a coordinate YL and a coordinate Yₘ;
a first comparator for receiving the coordinate XL and a coordinate 0;
a second comparator for receiving the coordinate XL and the coordinate Xₘ;
a third comparator for receiving the coordinate XL and a coordinate Xₘ+Xₛ;
a logic combining section for receiving output signals from the first through third comparators;
a first MUX for selecting one of the coordinate XL and an output signal from the subtracter in response to an output signal from the logic combining section and outputting the selected one as a coordinate XP; and
a second MUX for selecting one of the coordinate YL and an output signal from the adder in response to an output signal from the logic combining section and outputting the selected one as a coordinate YP;
wherein the coordinates XL and YL are coordinates on a window W1 of a logical display memory, the coordinates Xₘ and Yₘ are coordinates of the main display panel having a screen size of ₓₘ×Yₘ, the coordinate Xₛ is a coordinate of the sub display panel W2 having a screen size of Xₛ×Yₛ, and the coordinates XP and YP are coordinates of a physical video memory which correspond to the coordinates XL and YL on the window W1 of the logical display memory.

22. The device according to claim 20, wherein the window read/write circuit section comprises:
a first subtracter for receiving a coordinate Xe and a coordinate Xb;
a first register for storing an output signal of the first subtracter;
a first adder for receiving an output signal of the first register and adding one by one;
a second subtracter for receiving a coordinate Ye and a coordinate Yb;
a second register for storing an output signal of the second subtracter;
a second adder for receiving an output signal of the second register and adding one by one;
a multiplexer for selecting one of output signals from the first and second adders;
a third register for storing an output signal of the multiplexer;
a control logic part for receiving an output signal of the third register, a clock signal and a read/write command signal;
a counter circuit part for receiving an output signal of the control logic part;
a modifier for receiving output signals of the first register and the counter circuit part;
a divider for receiving output signals of the first register and the counter circuit part;
a third adder for receiving an output signal of the modifier and the coordinate Xb and generating the coordinate XL; and
a fourth adder for receiving an output signal of the divider and the coordinate Yb and generating the coordinate YL;
wherein the coordinates Xb and Yb and Xe and Ye are coordinates on a window of the logical display memory, the coordinates XL and YL are coordinates on the window of the logical display memory, and inequalities Xe>Xb and Ye>Yb are satisfied.
